(19) United States
(12) Patent Application Publication
(10) Pub. No.: US 2008/0041963 A1
(43) Pub. Date: Feb. 21, 2008

(54) Payment card holders

(75) Inventor: Trevor J. Sams, Totnes (GB)

Correspondence Address: WELSH & KATZ, LTD, 120 S RIVERSIDE PLAZA, 22ND FLOOR, CHICAGO, IL, 60606, US

(73) Assignee: Scope Communications UK Limited

(21) Appl. No.: 11/506,419

(22) Filed: Aug. 18, 2006

(51) Int. Cl. G06K 7/00; G06K 5/00

(52) U.S. Cl. 235/486; 235/380

(57) ABSTRACT

A payment card holder comprises a holding device for realeasably engaging with a payment card, a detection device for detecting the presence or absence of a payment card in the holding device, and an alarm device operable to receive a detection signal from the detection device and to enter an alarm condition when that detection signal is indicative of absence of the payment card in the holding device. The alarm device comprises a memory device for storing audio data, a microprocessor operable to output an audio data signal derived from stored audio data retrieved from the memory device, when the alarm device is in the alarm condition.

The present invention relates to payment card holders for use with wallets, purses and other bags that hold payment cards, such as credit or debit cards.

Forgetting to replace payment cards back into a payment card holder (such as a wallet, purse or other bag) is a well-known problem. For example, leaving a payment card behind at a retailer is all too common an occurrence. It has therefore been proposed to provide payment card holders with an alarm system that notifies the owner of a card when the card has been removed from the holder for longer than a specified period of time. However, such known devices are unsophisticated and can be limited in their operation.

Accordingly, it is desirable to provide a payment card holder for a wallet, purse or other bag which can be informative and programmable to the user's wishes.

According to one aspect of the present invention, there is provided a payment card holder comprising a holding device for realeasably engaging with a payment card, a detection device for detecting the presence or absence of a payment card in the holding device, and an alarm device operable to receive a detection signal from the detection device and to enter an alarm condition when that detection signal is indicative of absence of the payment card in the holding device, wherein the alarm device comprises a memory device for storing audio data, a microprocessor operable to output an audio data signal derived from stored audio data retrieved from the memory device, when the alarm device is in the alarm condition.

The alarm system may further comprise an interface for enabling data communication between the microprocessor and an external device.

The microprocessor may be operable to determine the alarm condition after a predetermined time period following receipt of the detection signal from the detection device indicating absence of the payment card.

The microprocessor may be operable to determine the alarm condition after a predetermined time period following receipt of the detection signal from the detection device indicating absence of the payment card, the predetermined time period being programmable by a user of the holder.

The stored audio data may be a MP3 encoded audio file, which may be received by the microprocessor via an interface for enabling data communication between the microprocessor and an external device.

The payment card holder may further comprise an opening case within which the holding device, detection device, and alarm device are accommodated. Such a holder may also comprise a magnetic locking device for locking the opening case, and an identification device for receiving identity data from a user, the magnetic locking device and the identification device being connected with the microprocessor for verification of an identity of a user, and for unlocking of the magnetic lock upon successful verification. The identification device may be chosen from a group consisting of a code number entry device and a fingerprint recognition device.

A payment card holder embodying the present invention may also comprise a radio frequency identification tag for storing owner identity information, and operable to supply that information to a radio frequency identification tag reader, and wherein the microprocessor is operable to supply owner information to the radio frequency identification tag for storage thereon.

It will be readily appreciated that a payment card holder embodying the present invention, and including one or more of the optional features mentioned, greatly improves on existing solutions by providing increased user features.

Reference will now be made, by way of example only, to the accompanying drawings, in which:

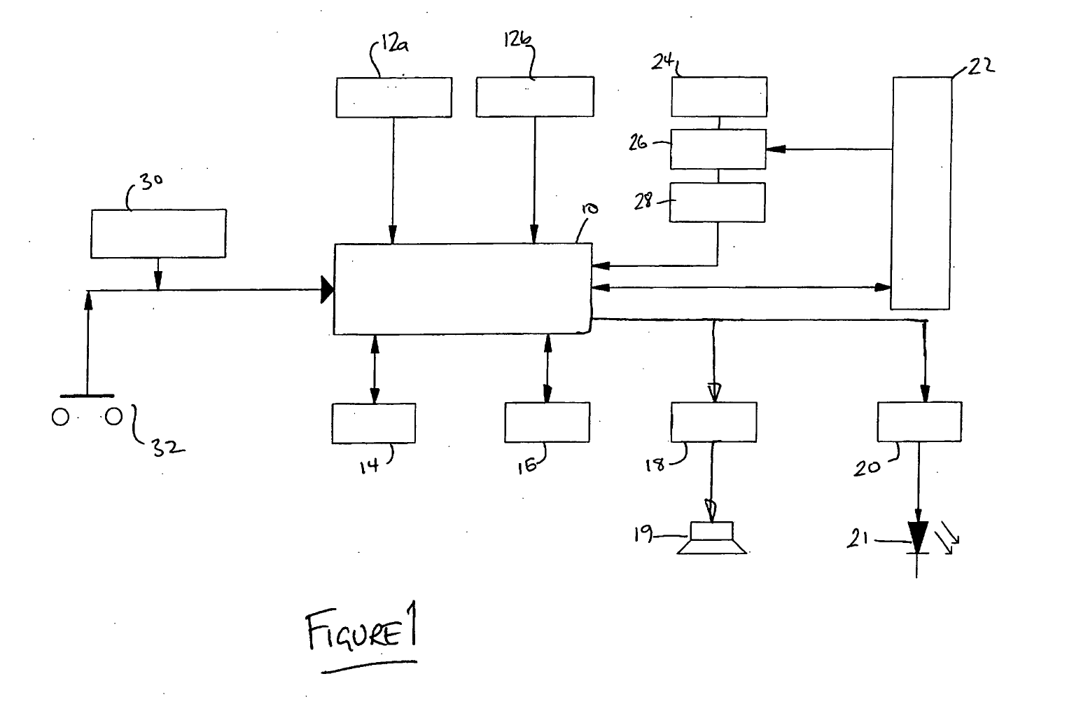

FIG. 1 is block diagram illustrating one embodiment of the present invention;

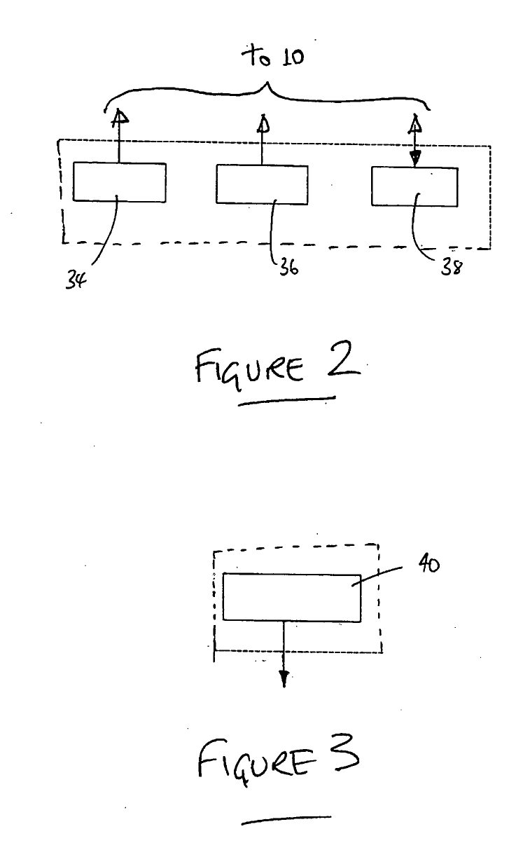

FIG. 2 is a block diagram illustrating optional additional units for connection to the embodiment of FIG. 1; and

FIG. 3 is a block diagram illustrating a further optional unit for connection to the embodiment of FIG. 1.

Embodiments of the present invention provide improved payment card holders which include an alarm system for alerting the user of the card holder to the absence of the card concerned. Although the cards are referred to in the present description as payment cards, which include credit and debit cards, it will be readily appreciated that the present invention is applicable to any type of card, such as an identity card or driving licence, which one would usually carry in a wallet or purse.

FIG. 1 is a block diagram illustrating a payment card alarm system embodying the present invention, which comprises a microprocessor 10 connected to transfer data with a read only memory (ROM) 14 and a random access memory (RAM) 60. The memory devices 14, 16 are used to store program data and other data for use by the microprocessor 10.

The system includes detection devices 12a and 12b that are connected to supply respective detection signals to the microprocessor 10, as will be explained in more detail below. It will be readily appreciated that any number of detection devices may be provided, and that the two illustrated in FIG. 1 are merely exemplary. In one particular example, the detection devices are simply arrays of contacts that close when the payment card being monitored is removed from between those contacts. The payment card is held in the holder between the contacts, such that when the card is removed from the holder, the contacts close and supply a detection signal, indicating an absence of the card, to the microprocessor 10.

The microprocessor 10 is connected to supply a driver signal to an audio coder/decoder (codec) 18, which, in turn, supplies an audio signal to a loudspeaker 19. In addition, the microprocessor controls an LED (light emitting diode) driver 20 which itself outputs an LED driver signal to a LED 21.

An interface 22 is provided for connecting a microprocessor 10 to a suitable programming device such as a personal digital assistant (PDA) or personal computer (PC). The interface device is preferably provided by a universal serial bus (USB) connection, but could be provided by any suitable interface device.

A battery 24 provides power for the alarm system, which is preferably a lithium ion (LION) battery. The battery is charged by a charger 26, which, in the embodiment shown in FIG. 1, receives power through the interface device 22. It will be appreciated that the charger can receive power from any suitable source. A voltage regulator 28 is provided in order to supply a regulated supply voltage to the microprocessor and other components of the system.

An RFID (Radio Frequency Identification) tag 30 is provided in order to identify the alarm system to an external RFID reader. A snooze button 32 is provided in order to temporarily disable the alarm system.

Operation of the system embodying the present invention will now be described with reference to FIG. 1. In operation, the microprocessor 10 receives detection signals from the detection devices 12a and 12b, and on reception of a detection signal indicating absence of the payment card to be monitored, produces an alarm condition. This alarm condition then causes an audio signal to be output via the codec 18 and the loudspeaker 19 and/or a visual signal to be output via the LED driver 20 and the LED 21.

In a preferred embodiment of the present invention, the microprocessor operates to store an audio data file in the memory device 16 for retrieval when outputting an alarm condition. For example, the audio data file could be an MP3 audio file or any suitable encoded audio file. The audio file is preferably supplied to the microprocessor and memory device via the interface device 22 from a suitable programming device, such as a PDA or PC. In this way, it is possible for the user to program and supply their own alarm signal in a manner akin to providing a ring tone on a mobile telephone.

The microprocessor 10 can also be programmed to set parameters for an alarm condition being triggered. The most significant parameter is the amount of time that must elapse before the alarm is triggered. Using a suitable programming device such as a PDA or PC that communicates with the microprocessor via the interface device 22, the user is able to set this time period.

FIG. 2 illustrates some optional units for connection to the microprocessor 10 of FIG. 1. The devices shown in FIG. 2 are particularly applicable to a hard backed container such as an aluminium case, which can be provided with additional security options when an embodiment of the present invention is fitted. The unit 34 is a number entry device, such as a keypad, for entering a combination to allow the case to be opened. An alternative method of opening a case could be provided by a fingerprint reader 36, and both of these devices server to supply identity information to the microprocessor 10 which in turn supplies an unlocking signal to a magnetic lock 38. In this manner, a container can be securely locked using the alarm system of the present invention with the additional components to enable identification of the user to the alarm system.

FIG. 3 illustrates a further optional component for connection to the microprocessor 10 of FIG. 1, which comprises a magnetic reader 40 for providing additional security features to the alarm system.

The alarm system embodying the present invention can be applied to any bag, wallet or purse, but is particularly suited for providing an alarm system for payment card holders. In particular, it is envisaged that the embodiment shown in FIG. 1 could be provided in a soft case with a number of alarmed payment card holders. An alternative embodiment would be the provision of a hard case, such as an aluminium case, in which alarmed payment card holders are provided. Such a hard case could be provided with the additional security features as shown in FIG. 2, to provided locking of the case itself.

The provision of an RFID tag 30 in embodiments of the present invention, enables owner information of the payment card holder to be stored securely within the holder itself. The RFID tag can be used to supply that information to a suitable RFID reader, which aids identification of the owner.

It will be readily appreciated that embodiments of the present invention provide significantly improved alarm systems for payment card holders, by allowing a user to program the alarm signal, the conditions for creating an alarm signal, and for providing additional security measures, particularly in the example of a payment card holder having a hard case.

1. A payment card holder comprising a holder for releasably retaining a payment card, a detection device for detecting the presence or absence of a payment card in the holder, and an alarm device operable to receive a detection signal from the detection device wherein the alarm device comprises:
a memory device for storing audio data;
a microprocessor operable to enter an alarm condition and when the detection signal is indicative of absence of the payment card to output an audio data signal derived from stored audio data retrieved from the memory device, in the alarm condition.

2. A holder as claimed in claim 1, wherein the memory device is operable to store user-defined data, which data define parameters for entering the alarm condition.

3. A holder as claimed in claim 2, wherein the parameters include elapsed time of the detection signal being indicative of the absence of the payment card.

4. A holder as claimed in claim 1, wherein the audio data is MP3 audio data.

5. A holder as claimed in claim 1, wherein the alarm device further comprises an interface device for enabling communication with an external device.

6. A holder as claimed in claim 1, wherein the alarm device further comprises a battery for supplying power to the alarm device, and an interface device for enabling communication with an external device, and for providing recharging power to the battery.

7. A holder as claimed in claim 1, comprising a soft outer case.

8. A holder as claimed in claim 1, comprising a hard outer case.

9. A holder as claimed in claim 1, wherein the alarm device further comprises a fingerprint recognition device operable to allow access to the holder.

10. A holder as claimed in claim 1, wherein the alarm device further comprises a snooze button which is operable to cause the microprocessor to delay entering the alarm condition.

11. A holder as claimed in claim 1, wherein the alarm device further comprises a radio frequency identification (RFID) tag for supplying identity information to a radio frequency reader device.

12. A holder as claimed in claim 1, wherein the alarm system further comprises a keypad for entry of a personal identification number for enabling access to the holder.

13. A holder as claimed in claim 1, wherein the alarm system further comprises a light emitting diode (LED), and wherein the microprocessor is operable to illuminate the LED when entering the alarm condition.
